(19) United States
(12) Patent Application Publication
(10) Pub. No.: US 2016/0023361 A1
(43) Pub. Date: Jan. 28, 2016

(54) Cutter

(71) Applicant: Cheng-Chang Tsai, Taichung City (TW)

(72) Inventor: Cheng-Chang Tsai, Taichung City (TW)

(21) Appl. No.: 14/340,644

(22) Filed: Jul. 25, 2014

(51) Int. Cl. B26B 17/00

(52) U.S. Cl. CPC B26B 17/00

(57) ABSTRACT

A cutter includes two handles, two jaws, two strips and two pins. The first jaw extends from the first handle in a co-planar manner and includes a boss and a blade with a cutting edge. The second jaw extends from the second handle in a co-planar manner and includes a groove for movably receiving the boss and a blade with a cutting edge. The strips sandwich the first and second jaws. Each of the pins is inserted in the strips and a corresponding one of the first and second jaws in perpendicular. An acute angle is defined between an equidistant line of the cutting edges and an equidistant line of axes of the pins.

### BACKGROUND OF INVENTION

1. Field of Invention

The present invention relates to a cutter and, more particularly, to an effective and efficient cutter.

2. Related Prior Art

As disclosed in Taiwanese Patent M321834, a cutter includes two elongated members 2 and 3. The elongated member 2 includes a blade 21 at an end and a handle 22 at another end. The blade 21 includes a cutting edge 211. The elongated member 3 includes a blade 31 at an end and a handle 32 at another end. The blade 31 includes a cutting edge 311. By a pin 4, the blade 21 is pivotally connected to two strips (not numbered) that sandwich the blades 21 and 31. The blade 31 is pivotally connected to the strips by another pin 4. The cutting edges are movable in a same plane as the handles. When the cutter is used to cut an object from a planar face of another object completely, the cutter must be placed close to the planar face. However, it is difficult for a user to comfortably maneuver the cutter and keep the cutter close to the planar face at the same time. Moreover, since there is no pin inserted in both of the blades 21 and 31, translation of the blade 21 relative to the blade 31 is allowed, and such translation renders the operation of the cutter unstable.

As disclosed in I419771, a cutter includes two elongated members. The first elongated member includes a blade 4 at an end and a handle 2 at another end. The blade 4 includes a cutting edge 12. The first elongated member is a bent element, i.e., the handle 2 and the blade 4 do not extend in a same plane. The second elongated member includes a blade 5 at an end and a handle 3 at another end. The blade 5 includes a cutting edge 11. The second elongated member is a bent element, i.e., the blade 5 and the handle 3 do not extend in a same plane. The blade 4 is pivotally connected to the blade 5 by a strip 8 and two pins 6 and 7. The blades 4 and 5 are movable in a same plane as the handles. An effective length of the handles 2 and 3 that is projected onto a plane that extends perpendicular to the pins 6 and 7 is shorter than the length of the handles 2 and 3. The effective length of the handles 2 and 3 of Taiwanese Patent I419771 is shorter than that of the handles 22 and 32 of Taiwanese Patent M381834. Hence, to provide a same torque on the blades for cutting, a user has to exert a larger force on the handles 2 and 3 of Taiwanese Patent I419771 than on the handles 22 and 32 of Taiwanese Patent M381834.Moreover, since there is no pin inserted in both of the blades 4 and 5, translation of the blade 4 relative to the blade 5 is allowed, and such translation renders the operation of the cutter unstable.

The present invention is therefore intended to obviate or at least alleviate the problems encountered in prior art.

### SUMMARY OF INVENTION

It is the primary objective of the present invention to provide an effective and efficient cutter.

To achieve the foregoing objective, the cutter includes two handles, two jaws, two strips and two pins. The first jaw extends from the first handle in a co-planar manner and includes a boss and a blade with a cutting edge. The second jaw extends from the second handle in a co-planar manner and includes a groove for movably receiving the boss and a blade with a cutting edge. The strips sandwich the first and second jaws. Each of the pins is inserted in the strips and a corresponding one of the first and second jaws in perpendicular. An acute angle is defined between an equidistant line of the cutting edges and an equidistant line of axes of the pins.

It is an advantage of the cutter of the present invention to provide slant cutting edges to cut an object from a planar object.

It is another advantage of the cutter of the present invention to provide a long effective length of the first and second handles that is essential for provision of adequate torque.

It is another advantage of the cutter of the present invention to provide only relative rotation, without any translation, between the first and second handles to ensure stable operation.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a cutter according to the preferred embodiment of the present invention;

FIG. 2 is an exploded view of the cutter shown in FIG. 1;

FIG. 3 is a partial and side view of the cutter shown in FIG. 1;

FIG. 4 is a top view of the cutter shown in FIG. 1;

FIG. 5 is another perspective view of the cutter shown in FIG. 1;

FIG. 6 is another perspective view of the cutter shown in FIG. 5; and

FIG. 7 is a partial and side view of the cutter shown in FIG. 6.

### DETAILED DESCRIPTION OF PREFERRED EMBODIMENT

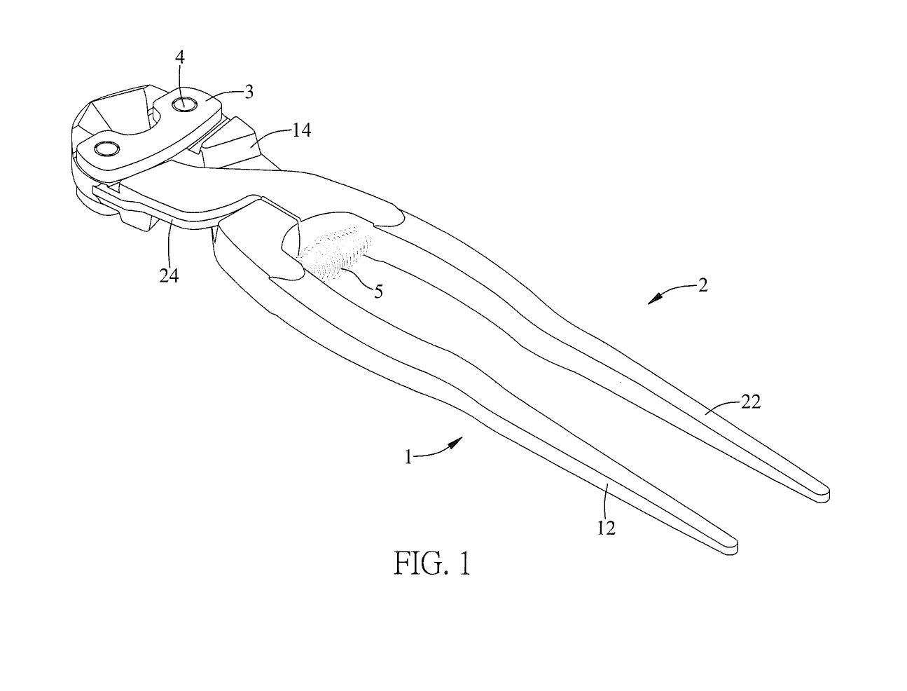

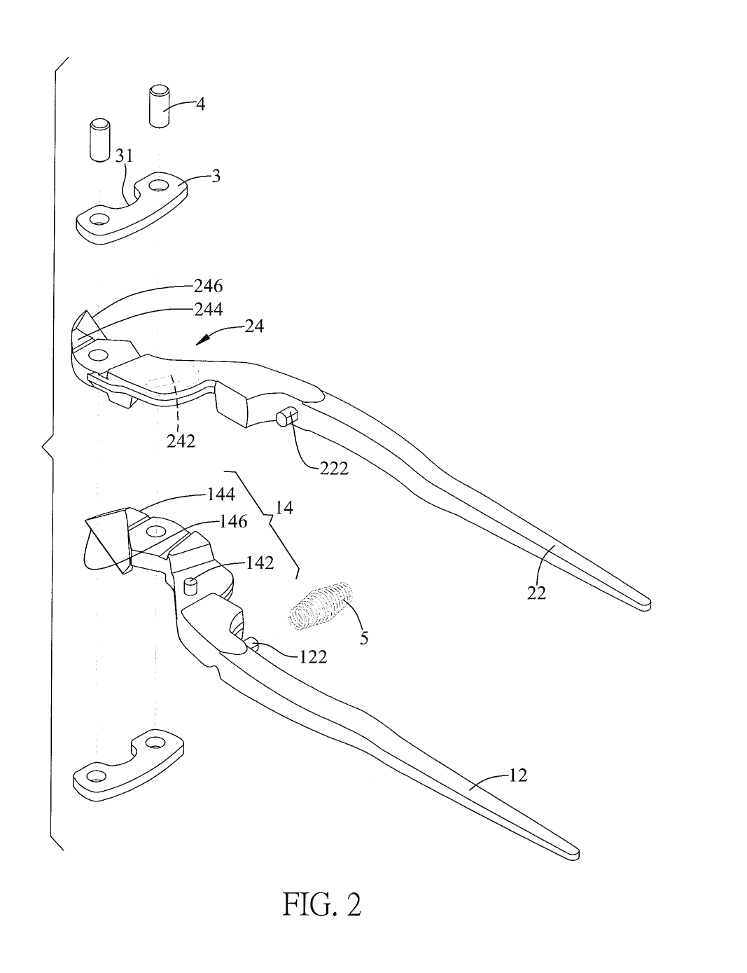

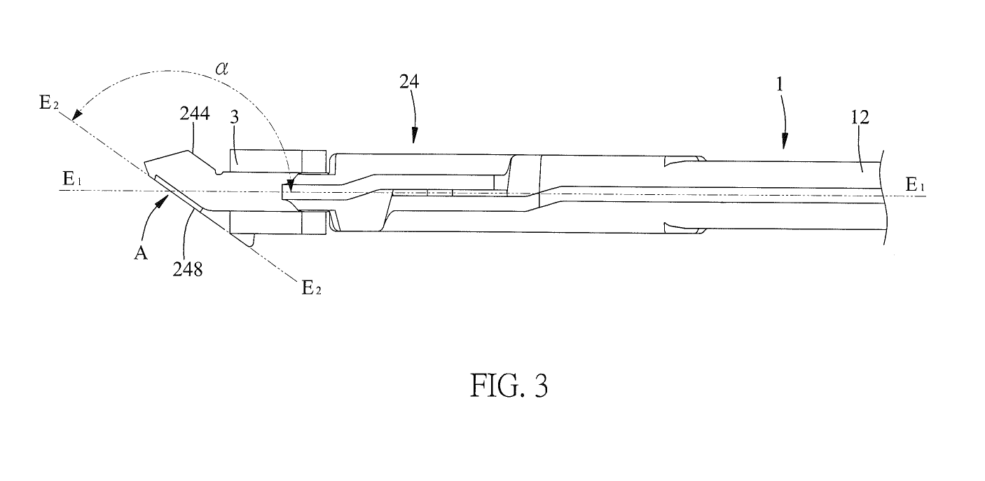

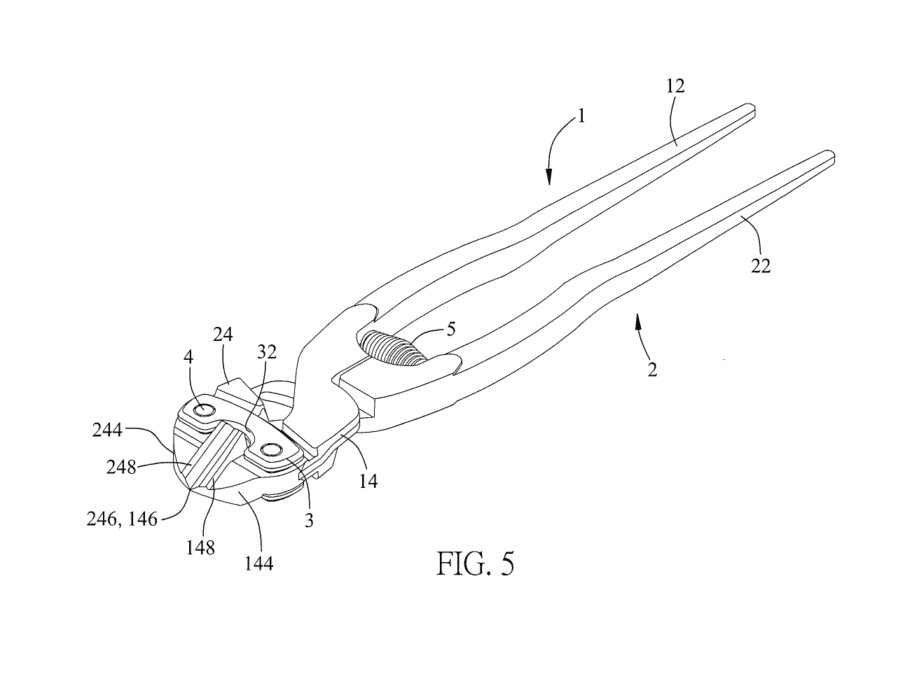

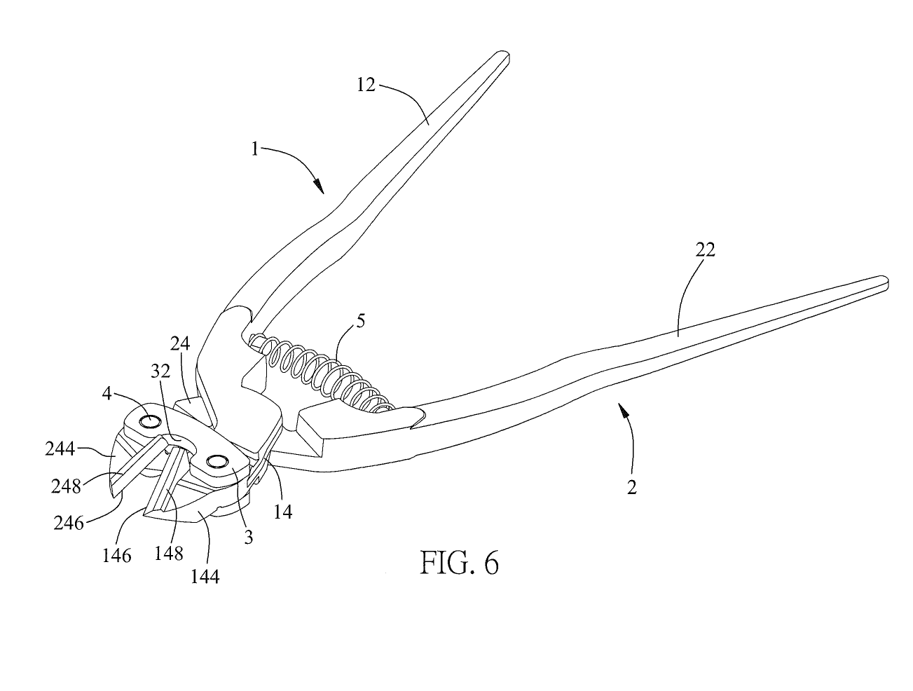

Referring to FIGS. 1 and 2, a cutter includes two elongated members 1 and 2 according to the preferred embodiment of the present invention. The first elongated member 1 includes a handle 12 at an end and a jaw 14 at another end. The handle 12 and the jaw 14 extend in a same plane. The handle 12 is formed with a boss 122 in the vicinity of the jaw 14. The jaw 14 includes a boss 142 on an upper face and a blade 144 at a free end. The blade 144 is formed with a cutting edge 146. Further referring to FIGS. 3, 5 and 6, there is a rib 148 extending parallel to the cutting edge 146.

The second elongated member 2 includes a handle 22 at an end and a jaw 24 at another end. The handle 22 and the jaw 24 extend in a same plane. The handle 22 is formed with a boss 222 in the vicinity of the jaw 24. The jaw 24 includes a groove 242 made in a lower face and a blade 244 at a free end. The blade 244 is formed with a cutting edge 246. Further referring to FIGS. 3, 5 and 6, there is a rib 248 extending parallel to the cutting edge 246.

The jaw 14 is pivotally connected to the jaw 24 by two strips 3 and two pins 4. One of the pins 4 is inserted in the strips 3 and the jaw 14. The other pin 4 is inserted in the strips 3 and jaw 24. A spring 5 includes two ends each connected to and, more particularly, fit on a corresponding one of the bosses 122 and 222. Each of strips 3 is made with a cutout 31 in a middle portion.

Referring to FIG. 3, the handle 1 and the jaw 3 extend along a first line E1-E1. Although not shown, the handle 2 and the jaw 4 also extend along the first line E1-E1. The rib 248 extends along a second line E2-E2. Although not shown, the rib 148 also extends along the second line E2-E2. The second line E2-E2 does not extend parallel to the first line E1-E1. There is an angle a between the second line E2-E2 and the first line E1-E1. The angle a is not equal to 180°.

As mentioned above, the cutting edge 146 extends parallel to the rib 148 while the cutting edge 246 extends parallel to the rib 248. Hence, it should easily be understood that the cutting edges 146 and 246 extend along a third line (not shown) that is an equidistant line of the cutting edges 146 and 246 and extends parallel to the second line E2-E2. The third line does not extend parallel to the first line E1-E1. There is an angle a between the third line and the first line E1-E1. That is, an acute angle is defined between the third line and an equidistant line of axes of the pins 4. Advantageously, this feature allows a user to use the cutter to cut an object from a planar face of another object completely.

Regarding torque, an effective length of the handles 1 and 2 is projected onto a plane that extends perpendicular to the pins 4. The effective length of the handles 1 and 2 is identical to the length of the handles 1 and 2 measured from the pins 4 to free ends of the handles 1 and 2 since the handles 1 and 2 substantially extend perpendicular to the pins 3. Advantageously, this feature allows the user to exert adequate torque for cutting.

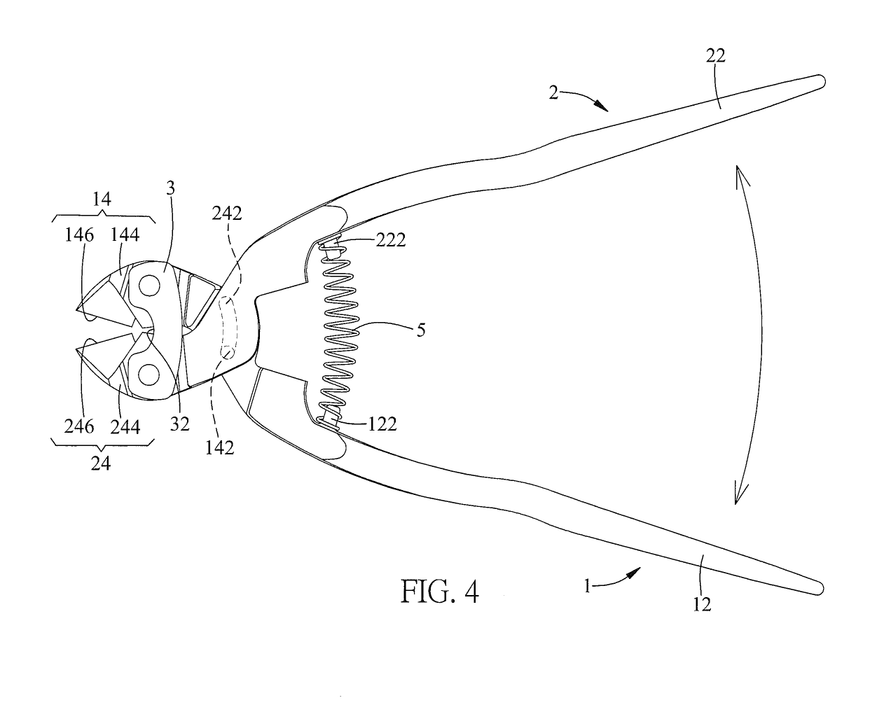

Referring to FIG. 4, the boss 142 is movably inserted in the groove 242. Hence, there is only rotation of the first elongated member 1 relative to the second elongated member 2 but there is no translation of the first elongated member 1 relative to the second elongated member 2. Advantageously, this feature provides stability during a cutting operation.

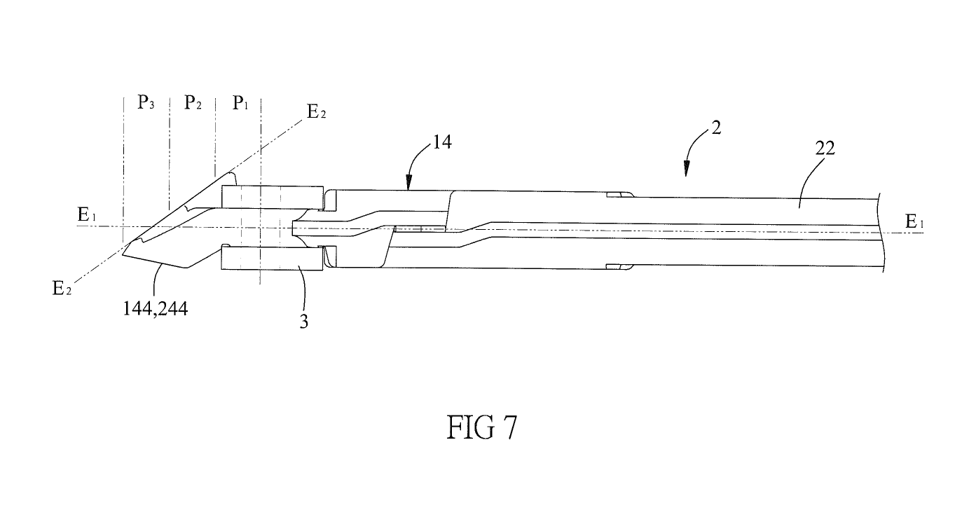

Referring to FIG. 7, the cutting edges 146 and 246 extend into the cutout 31 made in the middle portion of the lower strip 3. Hence, the cutting edges 146 and 246 extend adequately long. The cutting edges 146 and 246 can be divided into several portions P1, P2 and P3. The first portion P1 provides a higher mechanical advantage than the second portion P2. The second portion P2 provides a higher mechanical advantage than the third portion P3.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A cutter including:
a first handle 12;
a second handle 22;
a first jaw 14 extending from the first handle 12 in a co-planar manner and including:
a boss 142; and
a blade 144 including a cutting edge 146;
a second jaw 24 extending from the second handle 22 in a co-planar manner and including:
a groove 242 for movably receiving the boss 142; and
a blade 244 including a cutting edge 246;
two strips 3 for sandwiching the first and second jaws 14/24; and
two pins 4 each inserted in the strips 3 and a corresponding one of the first and second jaws 14/24 in perpendicular, wherein an acute angle is defined between an equidistant line of the cutting edges 146/246 and an equidistant line of axes of the pins 4.

2. The cutter according to claim 1, wherein the first blade 144 includes a rib 148 extending in parallel to the cutting edge 146, wherein the second blade 244 includes a rib 248 extending in parallel to the cutting edge 246.

3. The cutter according to claim 1, further including a spring 5 compressed between the first and second handles 12/22.

4. The cutter according to claim 3, wherein the first handle 12 includes a boss 122 fit in an end of the spring 5, wherein the second handle 22 includes a boss 222 fit in another end of the spring 5.

5. The cutter according to claim 1, wherein the each of the strips 3 includes a cutout 31 for receiving an end of each of the cutting edges 146/246.
